(19) United States
(12) Patent Application Publication
(10) Pub. No.: US 2021/0182757 A1
(43) Pub. Date: Jun. 17, 2021

(54) SERVER DEVICE, INFORMATION PROCESSING SYSTEM, NON-TRANSITORY STORAGE MEDIUM, AND METHOD FOR OPERATING INFORMATION PROCESSING SYSTEM

(71) Applicants: Toyota Jidosha Kabushiki Kaisha, Toyota-shi Aichi-ken (JP); Nomura Research Institute, Ltd., Tokyo (JP)

(72) Inventors: Daiki Kaneichi, Nisshin-shi (JP); Naoya Sugita, Tokyo (JP)

(73) Assignees: Toyota Jidosha Kabushiki Kaisha, Toyota-shi Aichi-ken (JP); Nomura Research Institute, Ltd., Tokyo (JP)

(21) Appl. No.: 17/110,668

(22) Filed: Dec. 3, 2020

(30) Foreign Application Priority Data
Dec. 12, 2019 (JP) 2019-224679

(51) Int. Cl. G06Q 10/06; H04W 4/90; H04W 4/12; G06Q 50/30; G06Q 50/26; G06Q 30/02; G08G 1/00

(52) U.S. Cl. CPC G06Q 10/06315; H04W 4/90; H04W 4/12; G06Q 20/123; G06Q 50/26; G06Q 30/0284; G08G 1/202; G06Q 50/30

(57) ABSTRACT

A server device includes a communication unit configured to communicate with a plurality of terminal devices and a control unit. The control unit is configured to mediate transmission and reception of information between the terminal devices via the communication unit and is configured to transmit a dispatch message including an offer to dispatch a vehicle to a first terminal device when an image object indicating a necessity of dispatching a vehicle is transmitted from the first terminal device to a second terminal device.

### CROSS-REFERENCE TO RELATED APPLICATION

This application claims priority to Japanese Patent Application No. 2019-224679 filed on Dec. 12, 2019, which is incorporated herein by reference in its entirety, including the specification, drawings and abstract.

### BACKGROUND

### 1. Technical Field

The present disclosure relates to server a device, an information processing system, a non-transitory storage medium, and a method for operating an information processing system.

### 2. Description of Related Art

Japanese Unexamined Patent Application Publication No. 2004-341872 (JP 2004-341872 A) discloses a technique of dispatching a taxi via a communication channel.

### SUMMARY

This technique has room for improvement in convenience of vehicle dispatch services.

The present disclosure provides a technique that improves the convenience of vehicle dispatch services.

A first aspect of the present disclosure is a server device. The server device includes a communication unit configured to communicate with a plurality of terminal devices and a control unit. The control unit is configured to mediate transmission and reception of information between the terminal devices via the communication unit and configured to transmit a dispatch message including an offer to dispatch a vehicle to a first terminal device when an image object indicating a necessity of dispatching a vehicle is transmitted from the first terminal device to a second terminal device.

In the first aspect, the control unit may be configured to dispatch a vehicle to a location of the first terminal device when the control unit receives an acceptance of the offer of the dispatch message from the first terminal device.

In the first aspect, the control unit may be configured to transmit the dispatch message to the first terminal device when a dispatch condition is satisfied. The dispatch condition may be a condition regarding at least one of a location of the first terminal device when the first terminal device transmits the image object to the second terminal device and a time when the first terminal device transmits the image object to the second terminal device.

In the first aspect, the dispatch condition may be that the location of the first terminal device when the first terminal device transmits the image object is different from an address of a user of the first terminal device.

In the first aspect, the dispatch condition may be that movement of the location of the first terminal device when the first terminal device transmits the image object is different from movement by a vehicle.

In the first aspect, the dispatch condition may be that the time when the first terminal device transmits the image object is outside operating hours of public transportation.

In the first aspect, the control unit may be configured to determine whether the image object indicates the necessity of dispatching the vehicle, based on a transmission manner in which the first terminal device transmitted the image object to the second terminal device in past.

In the first aspect, the transmission manner may be that a text message transmitted or received by the first terminal device to or from the second terminal device in association with the image object includes a predetermined keyword.

In the first aspect, the transmission manner may be that a location of the first terminal device when the first terminal device transmitted the image object is different from an address of a user of the first terminal device.

In the first aspect, the transmission manner may be that movement of a location of the first terminal device when the first terminal device transmitted the image object is different from movement by a vehicle.

In the first aspect, the transmission manner may be that a time when the first terminal device transmitted the image object is outside operating hours of public transportation.

In the first aspect, the control unit may be configured to reduce a fare for the dispatched vehicle in accordance with the number of times the first terminal device transmits the image object to the second terminal device.

In the first aspect, the control unit may be configured to transmit the image object to the second terminal device after the first terminal device performs a process of purchasing the image object from a vehicle dispatch service provider.

A second aspect of the present disclosure is an information processing system. The information processing system includes a first terminal device and a server device including a communication unit and a control unit. The communication unit is configured to communicate with a plurality of terminal devices. The control unit is configured to mediate transmission and reception of information between the terminal devices via the communication unit and configured to transmit a dispatch message including an offer to dispatch a vehicle to the first terminal device when an image object indicating a necessity of dispatching a vehicle is transmitted from the first terminal device to a second terminal device.

A third aspect of the present disclosure is a non-transitory storage medium. The non-transitory storage medium stores instructions that are executable by one or more processors and that cause the one or more processors to perform functions. The functions include: transmitting an image object indicating a necessity of dispatching a vehicle to a second terminal device via a server device configured to transmit and receive information to and from a first terminal device; and receiving from the server device a dispatch message including an offer to dispatch a vehicle.

In the third aspect, the functions may further include causing the server device to dispatch a vehicle to a location of the first terminal device, by transmitting an acceptance of the offer of the dispatch message from the first terminal device to the server device.

In the third aspect, the functions may further include: transmitting the image object to the second terminal device after performing a process for purchasing the image object from a vehicle dispatch service provider.

A fourth aspect of the present disclosure is a method for operating an information processing system. The information processing system includes plurality of terminal devices and a server device configured to mediate transmission and reception of information between or among the terminal devices. The method for operating the information processing system includes transmitting a dispatch message including an offer to dispatch a vehicle from the server device to a first terminal device when an image object indicating a necessity of dispatching a vehicle is transmitted from the first terminal device to a second terminal device.

In the fourth aspect, the method for operating the information processing system may further include causing the server device to dispatch a vehicle to a location of the first terminal device when the server device receives an acceptance of the offer of the dispatch message from the first terminal device.

In the fourth aspect, the method for operating the information processing system may further include: reducing a fare for the dispatched vehicle in accordance with the number of times the first terminal device transmitted the image object to the second terminal device.

According to the first, second, third, and fourth aspects of the present disclosure, the convenience of vehicle dispatch services is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates a configuration example of an information processing system;

FIG. 2 illustrates a configuration example of a terminal device;

FIG. 3 illustrates a configuration example of a server device;

FIG. 4 illustrates a configuration example of an on-board device;

FIG. 5 illustrates an example of a sequence of operations of the information processing system;

FIG. 6 illustrates an example of a sequence of operations of the information processing system; and

FIG. 7 illustrates an example of a display screen of the terminal device.

### DETAILED DESCRIPTION OF EMBODIMENTS

An embodiment will be described below.

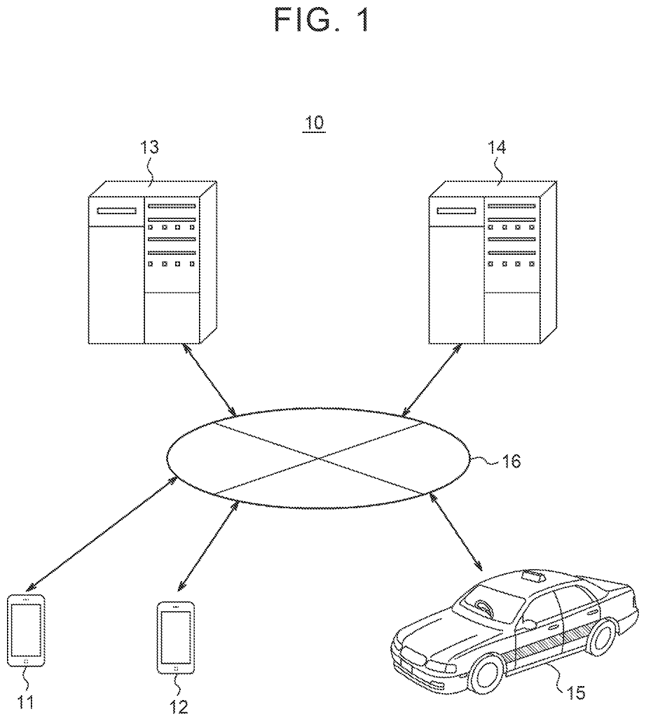

FIG. 1 illustrates a configuration example of an information processing system according to the embodiment. An information processing system 10 includes users' terminal devices 11, 12 and server devices 13, 14 that are connected via a network 16 such that the terminal devices 11, 12 and the server devices 13, 14 can communicate with each other via the network 16. One or more taxis 15 are connected to the network 16 such that the taxis 15 can communicate via their on-board devices. The terminal devices 11, 12 are, for example, mobile phones, smartphones, tablets, or personal computers (PCs). The server devices 13, 14 are, for example, server devices that belong to a cloud computing system or other computing system and that implement various functions. The network 16 is, for example, the Internet. The network 16 includes an ad hoc network, a local area network (LAN), a metropolitan area network (MAN), or other network, or any combination thereof.

Users (hereinafter respectively referred to as “U1” and “U2”) of the terminal devices 11, 12 use a social network service (SNS) service, which is provided by the server device 13, by executing an SNS application on the terminal devices 11, 12. The server device (hereinafter referred to as the “SNS server device”) 13 mediates transmission and reception of a text messages or an image object between the terminal devices 11, 12 using a chat function of the SNS. The users U1, U2 use a taxi dispatch service, which is provided by the server device 14, by executing a taxi dispatch application on the terminal devices 11, 12. In response to, for example, a request from the terminal device 11, the server device (hereinafter referred to as the taxi dispatch server device) 14 transmits a command to the taxi 15 to go to the location of the terminal device 11.

The information processing system 10 generally provides the SNS service and the taxi dispatch service to the user U1 as follows. When the SNS server device 13 mediates transmission and reception of an image object indicating the necessity of dispatching a taxi from the terminal device 11 to the terminal device 12 while the users U1, U2 are chatting on SNS using the terminal devices 11, 12, the SNS server device 13 transmits to the terminal device 11 a dispatch message an offer to dispatch a taxi. When the SNS server device 13 receives an acceptance of the offer from the terminal device 11, the SNS server device 13 causes the taxi dispatch server device 14 to dispatch the taxi 15 to the location of the terminal device 11. The SNS server device 13 and the taxi dispatch server device 14 correspond to the “server device” in the present embodiment.

The information processing system 10 provides the taxi dispatch service to the user U1 in response to transmission of an image object in the SNS service between the terminal devices 11, 12. The user U1 can therefore timely receive the taxi dispatch service even without having to start and operate the taxi dispatch application while using the SNS application on the terminal device 11. Convenience for the user U1 is thus improved.

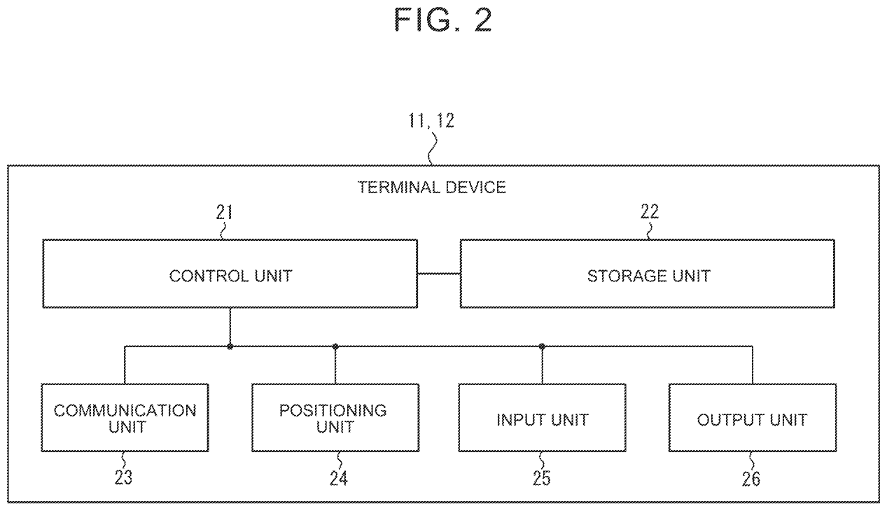

FIG. 2 illustrates a configuration example of the terminal device 11. The terminal device 11 includes a control unit 21, a storage unit 22, a communication unit 23, a positioning unit 24, an input unit 25, and an output unit 26. The terminal device 11 is, for example, a mobile phone, a smartphone, a tablet, or a PC. The following description of the configuration example is similarly applied to the terminal device 12.

The control unit 21 includes one or more processors, one or more dedicated circuits, or a combination thereof. The processor is, for example, a general-purpose processor such as a central processing unit (CPU), or a dedicated processor specialized in specific processing. The dedicated circuit is, for example, a field-programmable gate array (FPGA) or an application specific integrated circuit (ASIC). The control unit 21 performs information processing related to the operations of the terminal device 11 while controlling each unit of the terminal device 11.

The storage unit 22 includes one or more semiconductor memories, one or more magnetic memories, one or more optical memories, or a combination of at least two types of these memories. The semiconductor memory is, for example, a random access memory (RAM) or a read only memory (ROM). The RAM is, for example, a static RAM (SRAM) or a dynamic RAM (DRAM). The ROM is, for example, an electrically erasable programmable ROM (EEPROM). The storage unit 22 functions as, for example, a main storage device, an auxiliary storage device, or a cache memory. The storage unit 22 stores information that is used for the operations of the terminal device 11 and information obtained by the operations of the terminal device 11.

The communication unit 23 includes one or more communication interfaces. The communication interface is, for example, an interface corresponding to a mobile communication standard such as Long Term Evolution (LTE), 4th generation (4G), or 5th generation (5G), or a LAN interface. The communication unit 23 receives information that is used for the operations of the terminal device 11 and transmits information obtained by the operations of the terminal device 11. The terminal device 11 is connected to the network 16 by the communication unit 23 via a nearby router device or a nearby base station for mobile communication, and communicates with other devices via the network 16.

The positioning unit 24 includes one or more global navigation satellite system (GNSS) receivers. The GNSS includes, for example, at least one of the Global Positioning System (GPS), the Quasi-Zenith Satellite System (QZSS), the Global Navigation Satellite System (GLONASS), and Galileo. The positioning unit 24 acquires location information of the terminal device 11.

The input unit 25 includes one or more input interfaces. The input interface is, for example, a physical key, a capacitive key, a pointing device, a touch screen provided integrally with a display, or a microphone that receives voice input. The input interfaces may further include a camera that captures an image or an image code, or an IC card reader. The input unit 25 receives an operation to input information that is used for the operations of the terminal device 11, and transmits the input information to the control unit 21.

The output unit 26 includes one or more output interfaces. The output interface is, for example, an external or built-in display that outputs information as an image or a video, a speaker that outputs information as sound, or a connection interface with an external output device. The display is, for example, a liquid crystal display (LCD) or an organic electroluminescence (EL) display. The output unit 26 outputs information obtained by the operations of the terminal device 11.

The operations of the terminal device 11 are realized as the processor included in the control unit 21 executes a program. The program can be recorded on a computer-readable recording medium. The computer-readable recording medium is, for example, a magnetic recording device, an optical disc, a magneto-optical recording medium, or a semiconductor memory. The program is distributed in the form of a portable recording medium having the program recorded thereon, such as a digital versatile disc (DVD) or a compact disc (CD)-ROM. The program may be stored in a storage of a server device and may be distributed by transferring the program from the server device to other computers. A part or all of the operations of the terminal device 11 may be performed by the dedicated circuit included in the control unit 21.

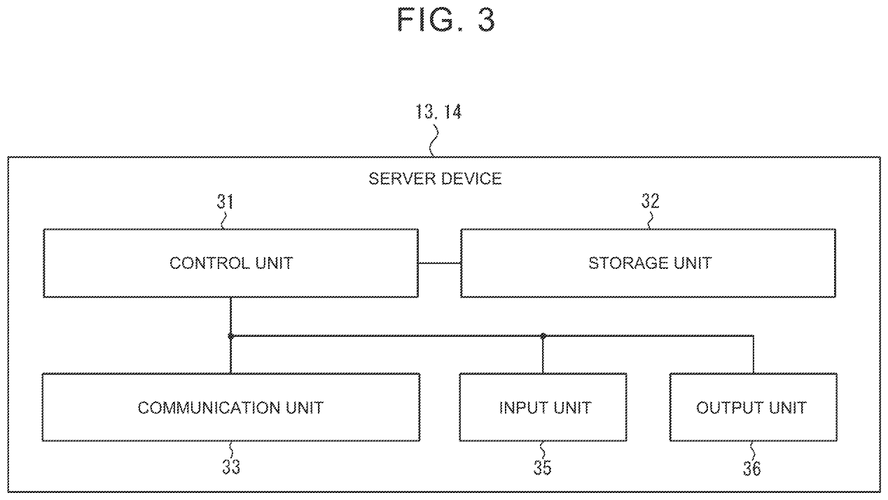

FIG. 3 illustrates a configuration example of the SNS server device 13. The SNS server device 13 includes a control unit 31, a storage unit 32, a communication unit 33, an input unit 35, and an output unit 36. The SNS server device 13 is, for example, a server that belongs to a cloud computing system or other computing system and that implements various functions. The following description of the configuration example is similarly applied to the taxi dispatch server device 14.

The control unit 31 includes one or more processors, one or more dedicated circuits, or a combination thereof. The processor is, for example, a general-purpose processor such as a CPU, or a dedicated processor specialized in specific processing. The dedicated circuit is, for example, an FPGA or an ASIC. The control unit 31 performs information processing related to the operations of the SNS server device 13 while controlling each unit of the SNS server device 13.

The storage unit 32 includes one or more semiconductor memories, one or more magnetic memories, one or more optical memories, or a combination of at least two types of the memories above. The semiconductor memory is, for example, a RAM or a ROM. The RAM is, for example, an SRAM or a DRAM. The ROM is, for example, an EEPROM. The storage unit 32 functions as, for example, a main storage device, an auxiliary storage device, or a cache memory. The storage unit 32 stores information that is used for the operations of the SNS server device 13 and information obtained by the operations of the SNS server device 13.

The communication unit 33 includes one or more communication interfaces. The communication interface is, for example, a LAN interface. The communication unit 33 receives information that is used for the operations of the SNS server device 13 and transmits information obtained by the operations of the SNS server device 13. The SNS server device 13 is connected to the network 16 by the communication unit 33 and communicates with other devices via the network 16.

The input unit 35 includes one or more input interfaces. The input interface is, for example, a physical key, a capacitive key, a pointing device, a touch screen provided integrally with a display, or a microphone that receives voice input. The input interfaces may further include a camera that captures an image or an image code, or an IC card reader. The input unit 35 receives an operation to input information that is used for the operations of the SNS server device 13, and transmits the input information to the control unit 31.

The output unit 36 includes one or more output interfaces. The output interface is, for example, a display or a speaker. The display is, for example, an LCD or an organic EL display. The output unit 36 outputs information obtained by the operations of the SNS server device 13.

Functions of the SNS server device 13 are realized as the processor included in the control unit 31 executes a control program. The control program is a program that causes a computer to perform the processes of steps included in the operations of the SNS server device 13 such that the computer realizes functions corresponding to the processes of the steps. That is, the control program is a program that causes the computer to function as the SNS server device 13. A part or all of the functions of the SNS server device 13 may be realized by the dedicated circuit included in the control unit 31.

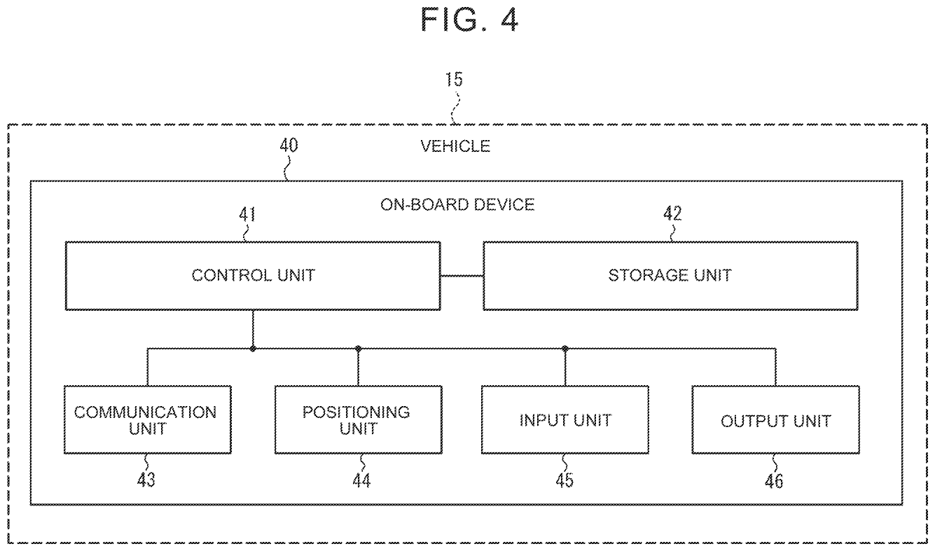

FIG. 4 illustrates a configuration example of an on-board device 40 that is mounted on the taxi 15. The on-board device 40 includes a control unit 41, a storage unit 42, a communication unit 43, a positioning unit 44, an input unit 45, and an output unit 46. The on-board device 40 is, for example, a navigation system, a mobile phone, a smartphone, a tablet, or a PC.

The control unit 41 includes one or more processors, one or more dedicated circuits, or a combination thereof. The processor is a general-purpose processor such as a CPU, or a dedicated processor specialized in specific processing. The dedicated circuit is, for example, an FPGA or an ASIC. The control unit 41 performs information processing related to the operations of the on-board device 40 while controlling each unit of the on-board device 40.

The storage unit 42 includes one or more semiconductor memories, one or more magnetic memories, one or more optical memories, or a combination of at least two types of the memories above. The semiconductor memory is, for example, a RAM or a ROM. The RAM is, for example, an SRAM or a DRAM. The ROM is, for example, an EEPROM. The storage unit 42 functions as, for example, a main storage device, an auxiliary storage device, or a cache memory. The storage unit 42 stores information that is used for the operations of the on-board device 40 and information obtained by the operations of the on-board device 40.

The communication unit 43 includes one or more communication interfaces. The communication interface is, for example, an interface corresponding to a mobile communication standard such as LTE, 4G, or 5G. The communication unit 43 receives information that is used for the operations of the on-board device 40 and transmits information obtained by the operations of the on-board device 40. The on-board device 40 is connected to the network 16 by the communication unit 43 via a base station for mobile communication and communicates with other devices via the network 16.

The positioning unit 44 includes one or more GNSS receivers. The GNSS includes, for example, at least one of GPS, QZSS, GLONASS, and Galileo. The positioning unit 44 acquires location information of the taxi 15.

The input unit 45 includes one or more input interfaces. The input interface is, for example, a physical key, a capacitive key, a pointing device, a touch screen provided integrally with a display, or a microphone that receives voice input. The input interfaces may further include a camera that captures an image or an image code, or an IC card reader. The input unit 45 receives an operation to input information that is used for the operations of the on-board device 40, and transmits the input information to the control unit 41.

The output unit 46 includes one or more output interfaces. The output interface is, for example, a display or a speaker. The display is, for example, an LCD or an organic EL display. The output unit 46 outputs information obtained by the operations of the on-board device 40.

Functions of the on-board device 40 are realized as the processor included in the control unit 41 executes a control program. The control program is a program that causes a computer to perform the processes of steps included in the operations of the on-board device 40 such that the computer realizes functions corresponding to the processes of the steps. That is, the control program is a program that causes the computer to function as the on-board device 40. A part or all of the functions of the on-board device 40 may be realized by the dedicated circuit included in the control unit 41.

The terminal devices 11, 12 and the SNS server device 13 that have the above configuration operate as follows when the user U1 chats with the user U2 on SNS.

When the user U1 transmits an instant message to the user U2, the control unit 21 of the terminal device 11 receives text input operation by the user U1 via the input unit 25 and generates an instant message including the input text. When the user U1 transmits an image object called a sticker etc. to the user U2, the control unit 21 of the terminal device 11 receives, via the input unit 25, an operation by the user U1 to call image objects and displays available image objects via the output unit 26. The control unit 21 displays, via the output unit 26, image objects stored in advance in the storage unit 22 or image objects received from the SNS server device 13 or the taxi dispatch server device 14 via the communication unit 23, for example. The control unit 21 receives selection of an image object by the user U1 via the input unit 25. The control unit 21 then receives a transmission command from the user U1 via the input unit 25 and transmits the generated instant message or the selected image object to the SNS server device 13 via the communication unit 23. The control unit 31 of the SNS server device 13 thus receives the instant message or the image object via the communication unit 33. The control unit 31 then transmits the received instant message or image object to the terminal device 12 of the user U2 via the communication unit 33. The control unit 21 of the terminal device 12 thus receives the instant message or the image object via the communication unit 23. The control unit 21 displays the received instant message or image object via the output unit 26. When the user U2 transmits an instant message or an image object to the user U1, the terminal device 12 performs the above operations of the terminal device 11, the terminal device 11 performs the above operations of the terminal device 12, and the SNS server device 13 transmits the instant message or image object received from the terminal device 12 to the terminal device 11.

In the present embodiment, the SNS server device 13 cooperates with the taxi dispatch server device 14 to transmit to the terminal device 11 a dispatch message including an offer to dispatch a taxi to the user U1. When the user U1 accepts the offer, the terminal device 11 transmits information indicating the acceptance of the offer to the SNS server device 13. In this case, the control unit 31 of the SNS server device 13 generates the dispatch message and transmits the message to the terminal device 11 of the user U1 via the communication unit 33. When the terminal device 11 receives the dispatch message from the SNS server device 13, the terminal device 11 displays the dispatch message to the user U1 and receives an input by the user U1 regarding whether to accept the offer. The control unit 21 receives the input by the user U1 indicating the acceptance of the offer via the input unit 25 and transmits information indicating the acceptance of the offer to the SNS server device 13 via the communication unit 23. The control unit 31 of the SNS server device 13 then transmits information regarding the dispatch to the taxi dispatch server device 14 via the communication unit 33.

The control unit 31 of the taxi dispatch server device 14 transmits and receives various types of information necessary for the dispatch to and from the SNS server device 13 and the on-board device 40 of the taxi 15 via the communication unit 33. The control unit 41 of the on-board device 40 transmits and receives various types of information necessary for the dispatch to and from the taxi dispatch server device 14 via the communication unit 43. The control unit 41 of the on-board device 40 displays information regarding the dispatch to a driver via the output unit 46 or receives an operation input by the driver via the input unit 45.

When the user U1 chats with the user U2 on SNS, the terminal devices 11, 12 display instant messages or image objects transmitted therebetween to the users U1, U2 as a chat history. Similarly, when the user U1 receives and responds to a dispatch message offer an offer to dispatch a taxi, the terminal device 11 displays to the user U1 the dispatch message and a response by the user U1 to the dispatch message together with the chat history. In this case, the control unit 21 of the terminal device 11 stores in the storage unit 22 the instant message, image object, dispatch message, and other information that are received from the SNS server device 13, and also stores in the storage unit 22 the instant message, image object, information indicating an acceptance of the offer, and other information that are transmitted to the SNS server device 13. The control unit 21 displays the stored instant messages etc. via the output unit 26.

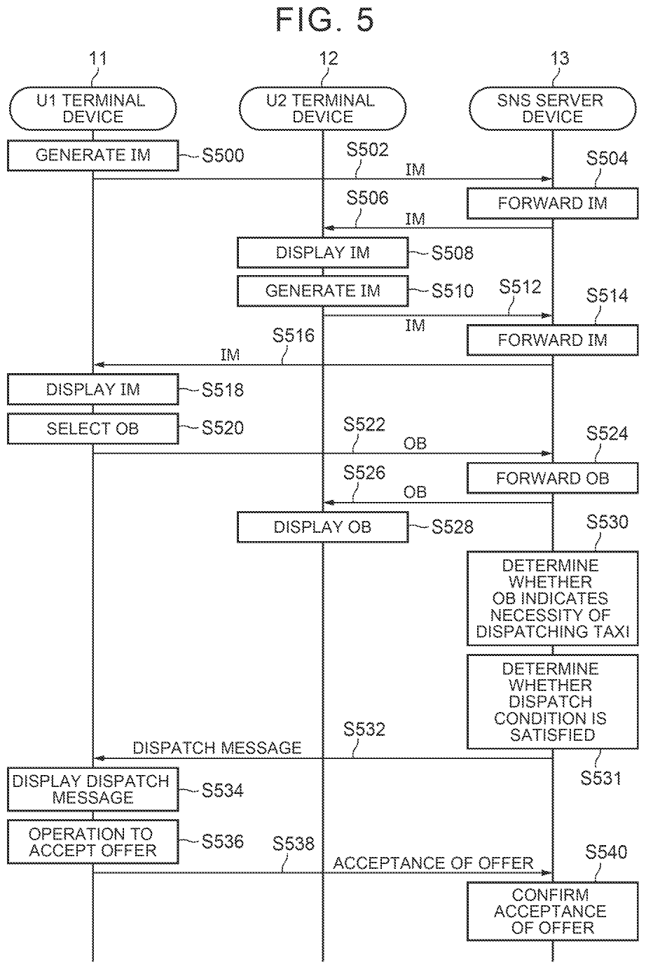

The operation procedure of the terminal device 11 of the user U1, the terminal device 12 of the user U2, and the SNS server device 13 when cooperating with each other will be described with reference to FIGS. 5 to 7.

FIG. 5 illustrates a sequence of operations of the terminal device 11 of the user U1, the terminal device 12 of the user U2, and the SNS server device 13 when cooperating with each other. The procedure in FIG. 5 is performed when the user U1 and the user U2 transmit instant messages to each other to chat on SNS.

In step S500 of FIG. 5, the terminal device 11 generates an instant message (denoted by “IM” in FIG. 5) for the user U2 in response to the operation by the user U1. In step S502, the terminal device 11 then transmits the instant message to the SNS server device 13, and the SNS server device 13 receives the instant message from the terminal device 11. In step S504, the SNS server device 13 performs a forwarding process of setting the destination of the instant message addressed to the user U2 to the terminal device 12. In step S506, the SNS server device 13 transmits the instant message to the terminal device 12, and the terminal device 12 receives the instant message transmitted from the SNS server device 13. In step S508, the terminal device 12 displays the received instant message to the user U2.

In step S510, the terminal device 12 of the user U2 generates an instant message for the user U1 in response to the operation by the user U2. In step S512, the terminal device 12 transmits the instant message to the SNS server device 13, and the SNS server device 13 receives the instant message transmitted from the terminal device 12. In step S514, the SNS server device 13 performs a forwarding process of setting the destination of the instant message addressed to the user U1 to the terminal device 11. In step S516, the SNS server device 13 transmits the instant message to the terminal device 11, and the terminal device 11 receives the instant message transmitted from the SNS server device 13. In step S518, the terminal device 11 displays the received instant message to the user U1.

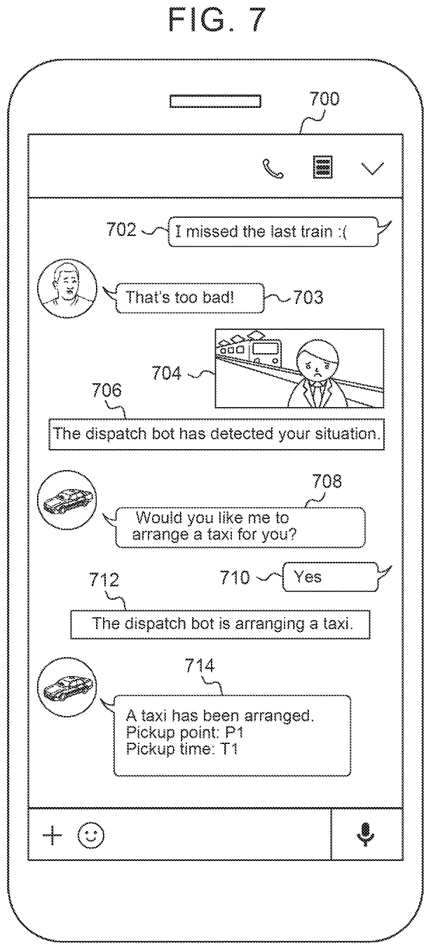

FIG. 7 illustrates an example of the display screen of the terminal device 11. In steps S500 to S518, an instant message 702 telling “I missed the last train :(” that is transmitted from the terminal device 11 to the terminal device 12, and an instant message 703 telling “That's too bad!” that is transmitted from the terminal device 12 to the terminal device 11, are displayed as a chat history on a display screen 700.

Referring back to FIG. 5, in step S520, the terminal device 11 receives the operation by the user U1 to select an image object (denoted by “OB” in FIG. 5). In step S522, the terminal device 11 transmits the selected image object to the SNS server device 13, and the SNS server device 13 receives the image object transmitted from the terminal device 11. In step S524, the SNS server device 13 performs a forwarding process of setting the destination of the image object addressed to the user U2 to the terminal device 12. In step S526, the SNS server device 13 transmits the image object to the terminal device 12, and the terminal device 12 receives the image object transmitted from the SNS server device 13. In step S528, the terminal device 12 displays the received image object to the user U2.

As shown in FIG. 7, an image object 704 that is transmitted from the terminal device 11 to the terminal device 12 in steps S520 to S528 and that indicates that the user U1 missed the last train, that is, indicates the necessity of dispatching a taxi, is displayed after the history of the instant messages 702, 703 on the display screen 700.

Referring back to FIG. 5, in step S530, the SNS server device 13 determines whether the image object indicates the necessity of dispatching a taxi. The control unit 31 of the SNS server device 13 stores in advance an image object determined to indicate the necessity of dispatching a taxi in the storage unit 32. The control unit 31 compares the transmitted image object with the image object stored in the storage unit 32 to determine whether these image objects are different from each other. The control unit 31 thus determines whether the transmitted image object indicates the necessity of dispatching a taxi.

The step of determining whether the image object indicates the necessity of dispatching a taxi may be performed before step S524 or may be performed during steps S524, S526.

In step S531, the SNS server device 13 determines whether a dispatch condition regarding either or both of the location of the terminal device 11 and the time when the image object is transmitted is satisfied. On condition that the dispatch condition is satisfied, the SNS server device 13 transmits to the terminal device 11 a dispatch message including an offer the user U1 to dispatch a taxi in step S532.

An example of the dispatch condition is that the location of the terminal device 11 is different from an address of the user U1. When the location of the terminal device 11 is the same as the address of the user U1, it is highly probable that the user U1 is already home and does not need a taxi even though the user U1 has transmitted the image object. It can therefore be determined that the dispatch condition is not satisfied. On the other hand, when the location of the terminal device 11 is different from the address of the user U1, it is highly probable that the user U1 needs a taxi to, for example, go home. It can therefore be determined that the dispatch condition is satisfied. For example, the control unit 31 of the SNS server device 13 stores in advance in the storage unit 32 the address of the user U1 as membership registration information for the SNS service. The control unit 31 compares the location of the terminal device 11, which is acquired from the terminal device 11 together with the instant message or the image object, with the address of the user U1 to determine whether the location of the terminal device 11 is different from the address the user U1.

Another example of the dispatch condition is that movement of the location of the terminal device 11 is different from the manner of movement by a vehicle. When the path or speed, or both, of the movement of the location of the terminal device 11 are the same as a typical path or speed, or both, of the movement by a vehicle, it is highly probable that the user U1 is already in a taxi and does not need a taxi. It can therefore be determined that the dispatch condition is not satisfied. On the other hand, when the path or speed, or both, of the movement of the location of the terminal device 11 are the different from the typical path or speed, or both, of the movement by a vehicle, it is highly probable that the user U1 is not in a taxi yet and needs a taxi. It can therefore be determined that the dispatch condition is satisfied. For example, the control unit 31 of the SNS server device 13 obtains the path or speed of the movement of the terminal device 11 from a change in location of the terminal device 11 with time that is acquired from the terminal device 11 together with the instant message or the image object. The control unit 31 compares the path of the movement of the terminal device 11 with a typical path for vehicle traffic (e.g., a freeway and a highway) on a map to determine whether the path of the movement of the terminal device 11 is different from the typical path for vehicle traffic on the map, or determines whether the speed of the movement of the terminal device 11 is within a typical range of the speed of the movement by a vehicle (e.g., 25 to 90 km/h). The SNS server device 13 thus determines whether the dispatch condition is satisfied.

A further example of the dispatch condition is that the time when the image object is transmitted is outside the operating hours of public transportation. When the time when the image object is transmitted is not outside the operating hours of public transportation, the user U1 may be able to use public transportation and it is therefore highly probable that the user U1 does not need a taxi. It can therefore be determined that the dispatch condition is not satisfied. On the other hand, when the time when the image object is transmitted is outside the operating hours of public transportation, the user U1 cannot use public transportation and it is therefore highly probable that the user U1 needs a taxi. It can therefore be determined that the dispatch condition is satisfied. For example, the control unit 31 of the SNS server device 13 checks the time when the image object is transmitted with the operating hours of public transportation stored in advance in the storage unit 32 and determines whether the time when the image object is transmitted is outside the operating hours of public transportation. The public transportation includes, for example, trains and fixed-route buses.

As described above, the dispatch message is transmitted on condition that the dispatch condition is satisfied. This improves accuracy in offering to dispatch a taxi when the user U1 needs a taxi. However, the dispatch message may be transmitted regardless of the dispatch condition. This process is also included in the scope of the present embodiment.

When the SNS server device 13 determines that the dispatch condition is satisfied, the SNS server device 13 transmits the dispatch message to the terminal device 11 and the terminal device 11 receives the dispatch message transmitted from the SNS server device 13 in step S532. In step S534, the terminal device 11 displays the dispatch message to the user U1. When the dispatch condition is not satisfied, the SNS server device 13 continues to mediate transmission and reception of a message or an image object between the terminal devices 11, 12.

As shown in FIG. 7, dispatch messages 706, 708 transmitted from the SNS server device 13 to the terminal device 11 in steps S530 to S532 are displayed on the display screen 700. The dispatch message 706 is a system message telling “The dispatch bot has detected your situation.” Displaying such a system message reduces a sense of abruptness to be given to the user U1. The dispatch message 708 is an instant message making the user U1 an offer “Would you like me to arrange a taxi for you?”

Referring back to FIG. 5, in step S536, the terminal device 11 receives the operation by the user U1 to accept the offer. In step S538, the terminal device 11 transmits information indicating the acceptance of the offer to the SNS server device 13, and the SNS server device 13 receives this information transmitted from the terminal device 11. The information indicating the acceptance of the offer is, for example, an instant message including any of affirmative words, such as “yes” and “please,” registered in advance in the storage unit 32 of the SNS server device 13. Alternatively, the dispatch message may have, as choices, objects that can be selected by the operation by the user U1 and may include information indicating that the user U1 has selected acceptance from the given choices. The user U1 may input such information indicating the acceptance of the offer to the input unit 25 by voice input. The information indicating the acceptance of the offer may include the location information of the terminal device 11. This eliminates the need for the user U1 to enter the pickup location to the terminal device 11 to transmit the pickup location to the SNS server device 13. In step S540, the SNS server device 13 confirms that the received information indicates acceptance of the offer. For example, the control unit 31 of the SNS server device 13 confirms the acceptance of the offer either by checking the received information with the words registered in advance in the storage unit 32 or based on the choice selected by the user U1. The control unit 31 may also acquire the location of the terminal device 11 as the pickup location of the user U1 and store the acquired location in the storage unit 32.

As shown in FIG. 7, an instant message 710 telling “Yes,” that is, indicating the acceptance of the offer, which has been transmitted from the terminal device 11 to the SNS server device 13 in step S538, is displayed on the display screen 700.

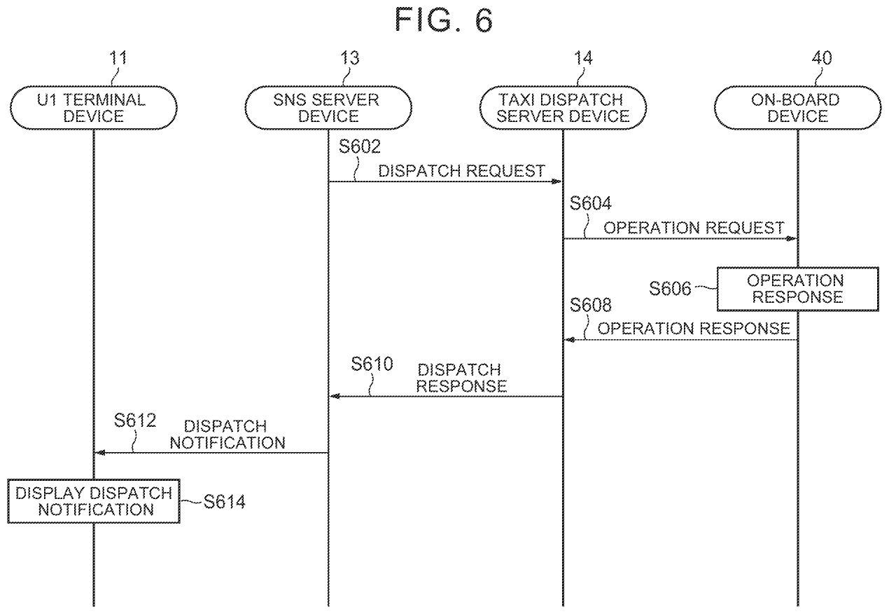

FIG. 6 illustrates an operation procedure for dispatching a taxi to the user U1 by the SNS server device 13 in cooperation with the taxi dispatch server device 14.

When the SNS server device 13 confirms the acceptance of the offer in step S540 of FIG. 5, the SNS server device 13 transmits a dispatch request together with the pickup location of the user U1 stored in the storage unit 32 to the taxi dispatch server device 14 and the taxi dispatch server device 14 receives the pickup location and the dispatch request from the SNS server device 13 in step S602 of FIG. 6.

In step S604, the taxi dispatch server device 14 generates an operation request corresponding to the received dispatch request and transmits the operation request to the on-board device 40, and the on-board device 40 receives the operation request transmitted from the taxi dispatch server device 14. The operation request includes the pickup location of the user U1.

In step S606, the on-board device 40 displays the pickup location included in the received operation request to the driver. The on-board device 40 receives an operation by the driver to answer whether the taxi 15 is available for the operation request, and generates an operation response regarding the availability of the taxi 15. When the on-board device 40 generates an operation response indicating that the taxi 15 is available, the on-board device 40 transmits the generated operation response to the taxi dispatch server device 14 and the taxi dispatch server device 14 receives the operation response transmitted from the on-board device 40 in step S608.

In step S610, the taxi dispatch server device 14 generates a dispatch response corresponding to the received operation response and transmits the generated dispatch response to the SNS server device 13, and the SNS server device 13 receives the dispatch response transmitted from the taxi dispatch server device 14. In this example, the dispatch response indicates that the taxi 15 is available.

In step S612, the SNS server device 13 generates a dispatch notification corresponding to the received dispatch response and transmits the generated dispatch notification to the terminal device 11 of the user U1, and the terminal device 11 receives the dispatch notification from the SNS server device 13. In this example, the dispatch notification indicates that the taxi 15 is available. During the period from the time the SNS server device 13 transmits the dispatch request to the taxi dispatch server device 14 in step S602 to the time the terminal device 11 receives the dispatch notification from the SNS server device 13 in step S612, the SNS server device 13 may transmit to the terminal device 11 an instant message indicating that a taxi is being arranged and the terminal device 11 may receive this instant message and display the received instant message to the user U1. In step S614, the terminal device 11 displays the received dispatch notification to the user U1.

As shown in FIG. 7, an instant message 712 indicating that a taxi is being arranged, telling “The dispatch bot is arranging a taxi,” is displayed on the display screen 700 after the history of the instant message 710 indicating the acceptance of the offer. Displaying such an instant message allows the user U1 to recognize that a taxi is being arranged and thus reduces the stress the user U1 may feel while waiting. An instant message 714 corresponding to the dispatch notification is displayed after the instant message 712. The instant message 714 indicates a pickup point and an estimated pickup time, such as “A taxi has been arranged. Pickup point: P1, Pickup time: T1.” This allows the user U1 to know when and where to expect the taxi to arrive and to take any necessary action.

As described above, according to the present embodiment, an offer to dispatch a taxi is made and a taxi is arranged while the user U1 is chatting with the user U2. The user U1 can thus receive the taxi dispatch service even without having to start and use the taxi dispatch application. Convenience of the taxi dispatch service is thus improved.

In the present embodiment, the SNS server device 13 determines whether an image object transmitted by the terminal device 11 is an image object indicating the necessity of dispatching a taxi, based on a transmission manner in which the user U1 transmits this image object from the terminal device 11 to terminal devices of other users including the user U2 in past.

An example of the transmission manner is that an instant message transmitted or received by the terminal device 11 to or from other terminal device in association with this image object includes a keyword indicating the necessity of dispatching a taxi. Examples of such a keyword include “miss * last train” (* is a wildcard that can be replaced with any character or any string of characters), “late for * last train,” “can't go home,” and “no * train.” Such keywords can be set as desired. For example, the control unit 31 of the SNS server device 13 searches for keywords stored in advance in the storage unit 32 in the instant message associated with the image object. When the number of keywords detected by the control unit 31 is equal to or greater than a reference value determined as desired, the control unit 31 determines that this image object is an image object indicating the necessity of dispatching a taxi. In this case, the control unit 31 adds, for example, tag information indicating that there is a need to dispatch a taxi to the image object, and stores the image object with the tag information in the storage unit 32. The control unit 31 compares the image object transmitted from the terminal device 11 with the image object stored in the storage unit 32 to determine whether the image objects are different from each other. The control unit 31 thus determines whether the image object transmitted from the terminal device 11 indicates the necessity of dispatching a taxi.

Another example of the past transmission manner that is used to determine that the image object indicates the necessity of dispatching a taxi is that the location of the terminal device 11 when the terminal device 11 transmits the image object in past is different from the address of the user U1. In the case where the terminal device 11 has transmitted the image object at the same location as the address of the user U1, it can be determined that the terminal device 11 has transmitted this image object when the user U1 is home and that this image object does not indicate the necessity of dispatching a taxi. On the other hand, in the case where the terminal device 11 has transmitted the image object at a location different from the address of the user U1, it can be determined that the user U1 uses this image object in, for example, a situation where the user U1 needs a taxi to get home and that this image object indicates the necessity of dispatching a taxi. For example, the control unit 31 of the SNS server device 13 counts the number of times the location of the terminal device 11 when the terminal device 11 transmits the image object in past is different from the address of the user U1 stored in advance in the storage unit 32, and stores the count value in the storage unit 32. When the count value is greater than a reference value determined as desired, the control unit 31 determines that this image object indicates the necessity of dispatching a taxi. In this case, the control unit 31 adds information indicating that there is a need to dispatch a taxi to this image object, and stores the image object with this information in the storage unit 32.

A further example of the past transmission manner that is used to determine that the image object indicates the necessity of dispatching a taxi is that movement of the location of the terminal device 11 when the terminal device 11 has transmitted the image object is different from movement by a vehicle. When the path or speed, or both, of the movement of the location of the terminal device 11 are the same as a typical path or speed, or both, of the movement by a vehicle, it is highly probable that the user U1 is already in a taxi. It can therefore be determined that the image object transmitted in such a situation does not indicate the necessity of dispatching a taxi. On the other hand, when the path or speed, or both, of the movement of the location of the terminal device 11 are the different from the typical path or speed, or both, of the movement by a vehicle, it is highly probable that the user U1 is not in a taxi yet and the image object has been transmitted in a situation in which the user U1 needs a taxi. It can therefore be determined that this image object indicates the necessity of dispatching a taxi. For example, the control unit 31 of the SNS server device 13 obtains the path or speed of the movement of the terminal device 11 from a change in location of the terminal device 11 that is acquired from the terminal device 11 together with the instant message or the image object. The control unit 31 counts the number of times at which the path of the movement of the terminal device 11 is different from a typical path for vehicle traffic on a map or the number of times the speed of the movement of the terminal device 11 is not within a typical range of the speed of the movement by a vehicle, and stores the count value in the storage unit 32. When the count value is greater than a reference value determined as desired, the control unit 31 determines that this image object indicates the necessity of dispatching a taxi. In this case, the control unit 31 adds information indicating that there is a need to dispatch a taxi to this image object, and stores the image object with this information in the storage unit 32.

A still further example of the past transmission manner that is used to determine that the image object indicates the necessity of dispatching a taxi is that the time when the image object is transmitted is outside the operating hours of public transportation. When the time when the image object is transmitted is not outside the operating hours of public transportation, the user U1 may be able to use public transportation. It can therefore be determined that there is no need to dispatch a taxi. On the other hand, when the time when the image object is transmitted is outside the operating hours of public transportation, the user U1 cannot use public transportation. It can therefore be determined that this image object indicates the necessity of dispatching a taxi. For example, the control unit 31 of the SNS server device 13 counts the number of times at which the image object is transmitted outside the operating hours of public transportation stored in the storage unit 32 in advance, and stores the count value in the storage unit 32. When the count value is greater than a reference value determined as desired, the control unit 31 determines that this image object indicates the necessity of dispatching a taxi. In this case, the control unit 31 adds information indicating that there is a need to dispatch a taxi to this image object, and stores the image object with this information in the storage unit 32.

Alternatively, the control unit 31 may determine that this image object indicates the necessity of dispatching a taxi when the number of times the movement of the location of the terminal device 11 after a predetermined time has elapsed since the image object is transmitted indicates the movement by a vehicle is greater than a predetermined value. In this case, it can be determined that the user U1 takes a taxi after a certain amount of time has elapsed since the image object is transmitted in a situation where there is a need to dispatch a taxi. In addition to the above, the control unit 31 may determine that the image object indicates the necessity of dispatching a taxi by performing machine learning of various training data associating an instant message associated with the image object, the time when the image object is transmitted, the location of the terminal device 11, etc. with a taxi ride history. Such training data includes, for example, transmission histories of image objects etc. by many and unspecified users and their taxi ride histories. That is, the control unit 31 can determine the image object indicating the necessity of dispatching a taxi by learning the transmission histories of image objects by many and unspecified users followed by their taxi rides. The necessity of dispatching a taxi that is associated with the image object is not limited to the case where the user misses the last train and may be in case of urgency. Based on the history of the user taking a taxi after transmitting an image object in association with a text message such as “I will be there soon,” the control unit 31 can determine that this image object indicates the necessity of dispatching a taxi. The necessity of dispatching a taxi may be the case where it is difficult to use public transportation such as when the user has a physical problem. Based on the history of the user taking a taxi after transmitting an image object in association with a text message such as “I got hurt” or “I am not feeling well,” the control unit 31 can determine that this image object indicates the necessity of dispatching a taxi.

In the present embodiment, the user U1 acquires an image object from an SNS service provider for a fee or free of charge. For example, the terminal device 11 downloads an image object from the website of an SNS service provided by the SNS server device 13 in response to the operation by the user U1 and pays for the image object as necessary by electronic payment. In this case, the SNS service provider defines in advance, for example, attributes of image objects and sells the image objects with their attributes added as tag information. In the case where the necessity of dispatching a taxi is defined as a part of the attributes, the control unit 31 of the SNS server device 13 can store in the storage unit 32 in advance the information that the image object indicates the necessity of dispatching a taxi. The control unit 31 can thus determine that the image object indicates the necessity of dispatching a taxi even when the manner in which this image object is used has not been accumulated.

In one example of the present embodiment, a taxi dispatch service provider that operates the taxi dispatch server device 14 provides image objects indicating the necessity of dispatching a taxi to the user U1 for a fee or free of charge. For example, the terminal device 11 downloads an image object from the website of the taxi dispatch service provided by the taxi dispatch server device 14 in response to the operation by the user U1 and thus acquires the image object free of charge or pays for the image object by electronic payment. When the user U1 transmits the image object acquired from the taxi dispatch service provider and receives the taxi dispatch service, the user U1 receives a discount on the taxi fare. For example, when the SNS server device 13 transmits a dispatch request to the taxi dispatch server device 14 (step S602 in FIG. 6), the SNS server device 13 transmits the image object received from the terminal device 11 to the taxi dispatch server device 14. The control unit 31 of the taxi dispatch server device 14 checks this image object with, for example, the record of providing image objects to the user U1, which is stored in the storage unit 32, and checks whether the image object provided to the user U1 is used. When dispatching the taxi 15, the taxi dispatch server device 14 instructs the on-board device 40 to give the user U1 a discount on the taxi fare. The discount amount may be determined according to the number of uses of the image object or may be determined for each image object. The taxi dispatch service provider or a taxi service provider can thus carry out their sales promotion activities through providing image objects.

The present disclosure is not limited to the above embodiment. For example, a plurality of blocks illustrated in each block diagram may be integrated, or one block may be divided into a plurality of blocks. Instead of performing the plurality of steps in the flowchart in a chronological order according to the description, the steps may be performed in parallel or in a different order either depending on the processing capability of the device that performs the steps or as necessary. Other modifications may be made without departing from the spirit and scope of the present disclosure.

What is claimed is:

1. A server device comprising:
a communication unit configured to communicate with a plurality of terminal devices; and
a control unit configured to
mediate transmission and reception of information between the terminal devices via the communication unit, and
transmit a dispatch message including an offer to dispatch a vehicle to a first terminal device when an image object indicating a necessity of dispatching a vehicle is transmitted from the first terminal device to a second terminal device.

2. The server device according to claim 1, wherein the control unit is configured to dispatch a vehicle to a location of the first terminal device when the control unit receives an acceptance of the offer of the dispatch message from the first terminal device.

3. The server device according to claim 1, wherein:
the control unit is configured to transmit the dispatch message to the first terminal device when a dispatch condition is satisfied; and
the dispatch condition is a condition regarding at least one of a location of the first terminal device when the first terminal device transmits the image object to the second terminal device and a time when the first terminal device transmits the image object to the second terminal device.

4. The server device according to claim 3, wherein the dispatch condition is that the location of the first terminal device when the first terminal device transmits the image object is different from an address of a user of the first terminal device.

5. The server device according to claim 3, wherein the dispatch condition is that movement of the location of the first terminal device when the first terminal device transmits the image object is different from movement by a vehicle.

6. The server device according to claim 3, wherein the dispatch condition is that the time when the first terminal device transmits the image object is outside operating hours of public transportation.

7. The server device according to claim 1, wherein the control unit is configured to determine whether the image object indicates the necessity of dispatching the vehicle, based on a transmission manner in which the first terminal device transmitted the image object to the second terminal device in past.

8. The server device according to claim 7, wherein the transmission manner is that a text message transmitted or received by the first terminal device to or from the second terminal device in association with the image object includes a predetermined keyword.

9. The server device according to claim 7, wherein the transmission manner is that a location of the first terminal device when the first terminal device transmitted the image object is different from an address of a user of the first terminal device.

10. The server device according to claim 7, wherein the transmission manner is that movement of a location of the first terminal device when the first terminal device transmitted the image object is different from movement by a vehicle.

11. The server device according to claim 7, wherein the transmission manner is that a time when the first terminal device transmits the image object is outside operating hours of public transportation.

12. The server device according to claim 1, wherein the control unit is configured to reduce a fare for the dispatched vehicle in accordance with a number of times the first terminal device transmits the image object to the second terminal device.

13. The server device according to claim 1, wherein the control unit is configured to transmit the image object to the second terminal device after the first terminal device performs a process of purchasing the image object from a vehicle dispatch service provider.

14. An information processing system comprising:
a first terminal device; and
a server device including a communication unit and a control unit, wherein
the communication unit is configured to communicate with a plurality of terminal devices, and
the control unit is configured to
mediate transmission and reception of information between the terminal devices via the communication unit,
transmit a dispatch message including an offer to dispatch a vehicle to the first terminal device when an image object indicating a necessity of dispatching a vehicle is transmitted from the first terminal device to a second terminal device.

15. A non-transitory storage medium storing instructions that are executable by one or more processors and that cause the one or more processors to perform functions comprising:
transmitting an image object indicating a necessity of dispatching a vehicle to a second terminal device via a server device configured to transmit and receive information to and from a first terminal device; and
receiving from the server device a dispatch message including an offer to dispatch a vehicle.

16. The non-transitory storage medium according to claim 15, the functions further comprising causing the server device to dispatch a vehicle to a location of the first terminal device, by transmitting an acceptance of the offer of the dispatch message from the first terminal device to the server device.

17. The non-transitory storage medium according to claim 15, the functions further comprising transmitting the image object to the second terminal device after performing a process for purchasing the image object from a vehicle dispatch service provider.

18. A method for operating an information processing system including a plurality of terminal devices and a server device configured to mediate transmission and reception of information between the terminal devices, the method comprising transmitting a dispatch message including an offer to dispatch a vehicle from the server device to a first terminal device when an image object indicating a necessity of dispatching a vehicle is transmitted from the first terminal device to a second terminal device.

19. The method for operating the information processing system according to claim 18, further comprising causing the server device to dispatch a vehicle to a location of the first terminal device when the server device receives an acceptance of the offer of the dispatch message from the first terminal device.

20. The method for operating the information processing system according to claim 18, further comprising reducing a fare for the dispatched vehicle in accordance with a number of times the first terminal device transmitted the image object to the second terminal device.
